(19) United States
(12) Patent Application Publication
(10) Pub. No.: US 2005/0270979 A1
(43) Pub. Date: Dec. 8, 2005

(54) Method for establishing a substitute path in a network

(76) Inventors: Uwe Pauluhn, Munchen (DE); Bernd Stilling, Munchen (DE)

Correspondence Address: Siemens Corporation;Intellectual Property Department, 170 Wood Avenue South, Iselin, NJ, 08830, US

(21) Appl. No.: 10/524,781

(22) PCT Filed: Aug. 11, 2003
(86) PCT No.: PCT/DE03/02697

§ 371 Date: Feb. 16, 2005

(30) Foreign Application Priority Data
Aug. 16, 2002 (DE) 102 37 584.4

(51) Int. Cl. H04L 1/00

(52) U.S. Cl. 370/238; 370/217; 370/221; 370/225

(57) ABSTRACT

The invention relates to a method for establishing a substitute path in a network with corresponding network nodes for path-switching between connection runs, whereby for the switching of path between two terminal nodes, a first network resource is used for the transmission and the signal transmission is interrupted in a connection run within said path. A substitute path is thus selected, in which the second resource to be selected must remain with a minimal resource loading on the switching of the network nodes. The establishment of the substitute path, corresponding to the second resource, is selected such that network nodes for the switching of retained connection runs between the original path and the substitute path must be minimally newly switched and new switching merely carried out for newly utilised connection runs.

### CROSS REFERENCE TO RELATED APPLICATIONS

This application is the US National Stage of International Application No. PCT/DE2003/002697, filed Aug. 11, 2003 and claims the benefit thereof. The International Application claims the benefits of German application No. 10237584.4 filed Aug. 16, 2002, both applications are incorporated by reference herein in their entirety.

### FIELD OF THE INVENTION

The invention relates to a method for managing resources when establishing a substitute path in a transparently switchable network.

### BACKGROUND OF THE INVENTION

From patent application DE 10105675.3 with date of publication 08.08.2002 a method is known for establishing a link in an optical WDM transmission system having a plurality of switchable optical network nodes of which at least one has a wavelength converter, whereby to establish a link from a first optical network node via at least one section of a link path to an Nth optical network node a first link vector for identifying WDM transmission channels available on the subsequent section of the link path is formed and is transmitted via the at least one WDM transmission system. By this means, a method is described for establishing a path for a transparent transmission of signals from a source node via switchable network nodes to a terminal node.

In the publication by G. Ahn et al., “Simulator for MPLS path restoration and performance evaluation”, Proceedings of “Joint 4th IEEE International Conference on ATM and High-speed Intelligent Internet Symposium”, 22 Apr. 2001, pages 31-36, methods for establishing a substitute path in MPLS (=multi-protocol label switching) networks are described. In particular, a “Simple-Dynamic Scheme” method is presented in section 2 which provides a minimally short substitute path for rerouting around the fault location (e.g. an imperfection) in a network. If a fault is detected in a network node, by means of the “Simple-Dynamic Scheme” method a new substitute path to a PML (=protection merging label switching router) is switched via the shortest transmission path, no working path being utilized.

From the publication by C. Baworntummaratarat et al. “On the comparison of optical WDM mesh network protection strategies”, Conference Proceedings Milcom 2000, 21st Century Military Communications Conference, 22-25 Oct. 2000, Vol. 2 pages 886-891, a method for establishing a substitute path in WDM networks is also known. A distinction is drawn between “link restoration” and “path restoration”. In the case of the “link restoration” method, the interrupted data traffic is routed around the fault location, whereas in the case of the “path restoration” method, the interrupted data traffic is routed on a completely new path from a source node to a destination node. Although the “link restoration” method is fast because it has the advantage of removing a fault locally and transparently, it is not suitable for networks with many wavelengths since the availability of free wavelength channels is still limited. For the “path restoration” method, three options are presented in the publication. These are the “Minimal cost” method, the “Disjoint path” method and the “Single link basis” method. All the methods are what are known as pre-planned or pre-negotiated restoration/protection methods in which the route of the substitute path is determined and stored even before the occurrence of a fault.

In an automatic switched transport network (ASTN) such as for example an optical transparent network, at a location of a transmission fault e.g. as the result of the failure of a link in a switched path with a first network resource between two terminal nodes, a substitute path with rerouting around the fault location is established. For this purpose a further network resource is needed for establishing and switching the substitute path. The switchover between a path and a substitute path is carried out by means of new switchings at the terminal nodes and in accordance with the two resources for the further switchings of the interposed network nodes.

In order to configure the rerouting, two restoration methods are principally available through local or global configuration of the substitute path (local repair, global repair). An introduction to these two methods is described in an Internet publication “Framework for MPLS-based Recovery http://search.ietf.org/internet-drafts/draft-ietf-mpls-recovery-frmwrk-03.txt”, Vishal Sharma et al., July 2001.

In the case of local configuration, a shortest possible rerouting around a fault location is established. The establishment of this rerouting is initiated by the network node which is connected immediately upstream of the faulty link section. The establishment is carried out relatively fast, but the resources for new switching do not remain optimal in terms of loading since all switchings in the original path are disconnected and furthermore new switchings for the substitute path are established by means of a new resource. In the case of global configuration, the substitute path is recalculated as being a complete path from source node X to the terminal node Y and is established through new switchings at the interposed original network nodes still being used and at the newly introduced network nodes. This second method enables better utilization of the resources of the network for the substitute path, but has the disadvantage of being slow.

### SUMMARY OF THE INVENTION

The object of the invention is to specify a method for establishing a substitute path in a network, which method enables optimum use of the resources of the network.

The object is achieved by the claims.

According to the invention, in order to configure the new resource for the switching of link sections of a substitute path, only the changed and necessary new switchings of the newly required link sections and the link sections used for the previous path. This has the advantage that the management of resources for all paths of the network is made considerably easier overall because resources for the corresponding new switching of a transparent link between two network locations from newly established paths are generated not completely anew but from established resources of existing paths.

In a rerouting of signals e.g. due to an interruption of a link section or a defective network node or where a fully loaded transmission capacity is determined in a path, the method according to the invention is carried out section-wise automatically.

In particular also in the switching of new link sections for the rerouting of signals, a switching has to be carried out at the network nodes at which the signals are decoupled from and recoupled to the original path, which switching is adapted to the new rerouting of the link. Likewise, a minimum number of new switchings can be carried out in the new link sections and network nodes in the rerouting if the original configuration of the switching settings is known in the rerouting.

The invention is not limited to a granularity (spatial switching, group or single wavelength switching, polarization switching, etc.) of the channels in the network in which channels the signals are transmitted. Different multiplexing techniques can be used for transmitting the signals. The link sections may consist of a plurality of waveguides and optical fibers.

Advantageous further developments of the invention are specified in the dependent claims.

### BRIEF DESCRIPTION OF THE DRAWING

An exemplary embodiment of the invention is explained in more detail below with reference to the drawing, in which

FIG. 1 shows a schematic representation of a network with an interruption in a link section.

### DETAILED DESCRIPTION OF THE INVENTION

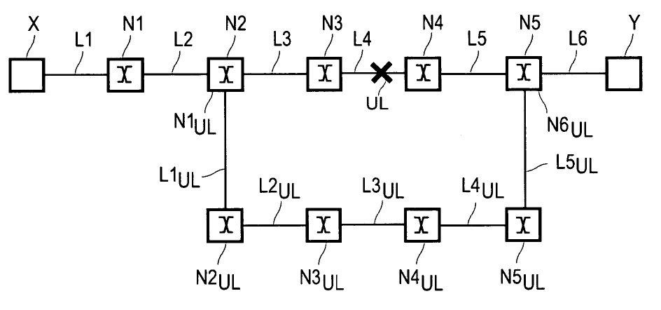

FIG. 1 shows schematically a network, e.g. as an optical transparent network with an interruption as a fault location UL in a link section L4. For reasons of clarity, only link sections L1, L2, L3, L4, L5, L6 and interposed network nodes N1, N2, N3, N4, N5 for a path for signal transmission from a source node X to the terminal node Y are shown, whereby the interruption occurs in the link section L4. At the network node N3 the interruption is identified in the link section UL and an error message containing path and link ID transmitted via the network nodes N2, N1 to the source node X. This is made possible because the link between the source node X and the network node N3 is still functional.

In the event of there being a defect in the network node N3 itself rather than in the link section L4, the network node N2 takes over the communication of the error message to the source node X. The communication of the error message to the source node X always occurs from the intact network node connected upstream of the fault location UL.

A plurality of fault locations can also be detected whereby, where there are e.g. two fault locations, firstly the first is updated in accordance with the inventive method according to a second resource by the first resource and then the third by the second resource. In other words, the resource of the path is compared with the resources of successive substitute paths upstream such that the resources are updated in succession according to the invention for as long as an error message is delivered to the source node. The fault location nearest to the source node is firstly rerouted around and the other fault locations upstream as far as the fault location nearest to the terminal node Y are then rerouted around with the substitute paths. Switchings of identically used link sections between the original path and all substitute paths are retained, i.e. not newly switched.

For the switching of link sections in the network nodes of the original path a first resource of the network was used for transmission.

Upon receipt of the error message at the source node X a substitute path is chosen for rerouting around the interrupted link section L4 between the source and terminal nodes X, Y according to a second resource yet to be established. The choice of the substitute path can be carried out in accordance with different methods known from the prior art. As an example, two methods are based, as mentioned in a previous section of the description, on local or global configuration of a substitute path (“local repair” or “global repair”). In the method according to the invention, a global configuration of a substitute path is used as a restoration method, but the original path is not yet disconnected in the restoration.

The optimum path from the source node X to the terminal node Y is determined by means of the routing protocol, whereby the resource of the previous path is also utilized. In order to configure a second resource of the network for the switching of link sections of the substitute path, only the link sections L1_{UL}, L2_{UL}, . . . , L5_{UL}, disposed in the rerouting, with associated network nodes N1_{UL}, N2_{UL}, . . . , N6_{UL} are newly switched by means of a control signal emitted from the source node X. Here, the network nodes N1_{UL} and N6_{UL} in the substitute path are the network nodes N2, N5 of the previous path.

The source node X initiates the establishment of the substitute path by checking in each individual network node of the path whether the new switched link is identical with the switched link of the original path. Two cases occur:
1. Case 1 (identical): No new (physical) switching has to be carried out, the resource of the old path has merely to be assigned to the substitute path (path ID of the old path is replaced by the new path ID). Here, the switchings with the components X, L1, N1, L2 and L6, Y are retained.
2. Case 2 (not identical): The resource reserved for the old path in the network node under consideration—L3, N3, L4, N4, L5—is released and the new link—N2=N1_{UL}, L1_{UL}, N2_{UL}, . . . , L5_{UL}, N5=N6_{UL}—is switched.

The resources are then released in the network nodes along the portion of the old path no longer needed.

1-6. (canceled)

7. A method for managing resources when establishing a substitute path from a source node to a terminal node in a transparently switchable network for signal transmission, wherein the source node and the terminal node are connected to a plurality of network nodes having interposed link sections, the method comprising:
providing switching devices in the network nodes, in the source nodes, and in the terminal nodes for switching a plurality of paths for signal transmission between the source node and the terminal node;
utilizing a first network resource controlled by the source node for the signal transmission and for switching of the link sections within one of the paths, wherein the signal transmission is interrupted upon occurrence of an imperfection in the one path and an error message is transmitted from a network node to the source node, the network node arranged upstream of the imperfection relative to a signal transmission direction;
determining, upon receipt of the error message, by the source node a substitute path for rerouting the signal transmission around the imperfection using a control signal generated by the source node; and
establishing a second resource for switching the link sections of the substitute path such that only such link sections disposed in the rerouting and in need of reswitching are newly switched by the network nodes included in the rerouting, wherein the second resource is established using the control signal and the first resource, and wherein switched link sections common to the path and the substitute path are maintained.

8. The method according to claim 7, wherein the maintained switched link sections commonly assigned to the original path and to the substitute path and the necessary switching of link sections of the rerouting and the release of the link sections from the original path no longer used in the substitute path are controlled by setting up the second resource from an updating of the first resource at the respective network nodes.

9. The method according to claim 7, wherein the link sections disposed in the rerouting are switched with a minimum number of new switchings by the network nodes.

10. The method according to claim 8, wherein the link sections disposed in the rerouting are switched with a minimum number of new switchings by the network nodes.

11. The method according to claim 7, wherein, when there is a plurality of imperfections in the path, firstly the imperfection nearest to the source node is rerouted around with a first substitute path and thereafter the other imperfections in succession upstream are rerouted around with further substitute paths, wherein
the resource of one of the substitute paths to be established is updated from the previous established resource of the path or substitute path, and wherein
switchings of identically used link sections between the original path and the respective substitute paths are maintained.

12. The method according to claim 8, wherein, when there is a plurality of imperfections in the path, firstly the imperfection nearest to the source node is rerouted around with a first substitute path and thereafter the other imperfections in succession upstream are rerouted around with further substitute paths, wherein
the resource of one of the substitute paths to be established is updated from the previous established resource of the path or substitute path, and wherein
switchings of identically used link sections between the original path and the respective substitute paths are maintained.

13. The method according to claim 9, wherein, when there is a plurality of imperfections in the path, firstly the imperfection nearest to the source node is rerouted around with a first substitute path and thereafter the other imperfections in succession upstream are rerouted around with further substitute paths, wherein
the resource of one of the substitute paths to be established is updated from the previous established resource of the path or substitute path, and wherein
switchings of identically used link sections between the original path and the respective substitute paths are maintained.

14. The method according to claim 10, wherein, when there is a plurality of imperfections in the path, firstly the imperfection nearest to the source node is rerouted around with a first substitute path and thereafter the other imperfections in succession upstream are rerouted around with further substitute paths, wherein
the resource of one of the substitute paths to be established is updated from the previous established resource of the path or substitute path, and wherein
switchings of identically used link sections between the original path and the respective substitute paths are maintained.

15. The method according to claim 7, wherein at each network node switching between channels is carried out for the transmission of signals with differing granularities.

16. The method according to claim 8, wherein at each network node switching between channels is carried out for the transmission of signals with differing granularities.

17. The method according to claim 9, wherein at each network node switching between channels is carried out for the transmission of signals with differing granularities.

18. The method according to claim 10, wherein at each network node switching between channels is carried out for the transmission of signals with differing granularities.

19. The method according to claim 11, wherein at each network node switching between channels is carried out for the transmission of signals with differing granularities.

20. The method according to claim 12, wherein at each network node switching between channels is carried out for the transmission of signals with differing granularities.

21. The method according to claim 13, wherein at each network node switching between channels is carried out for the transmission of signals with differing granularities.

22. The method according to claim 14, wherein at each network node switching between channels is carried out for the transmission of signals with differing granularities.
